(19) United States
(12) Patent Application Publication
(10) Pub. No.: US 2008/0075847 A1
(43) Pub. Date: Mar. 27, 2008

(54) INKJET RECORDING MEDIUM PRODUCTION METHOD

(75) Inventor: Masamichi Kobayashi, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/863,170

(22) Filed: Sep. 27, 2007

(30) Foreign Application Priority Data
Sep. 27, 2006 (JP) 2006-262052

(51) Int. Cl. B41M 5/00

(52) U.S. Cl. 427/152; 427/146

(57) ABSTRACT

An inkjet recording medium production method including at least forming an ink absorbing layer on or above a support, wherein the ink absorbing layer includes vapor-phase silica and at least two matting agents having different number average particle diameters and having distribution degree of 0.2 or less, and an inkjet recording medium production method including at least forming an ink absorbing layer and a glossy layer on or above a support, wherein the ink absorbing layer includes vapor-phase silica, the glossy layer includes colloidal silica, and either the ink absorbing layer or the glossy layer includes at least two matting agents having different number average particle diameters and having distribution degree of 0.2 or less.

### CROSS-REFERENCE TO RELATED APPLICATION

This application claims priority under 35 U.S.C. 119 from Japanese Patent Application No. 2006-262052, the disclosure of which is incorporated by reference herein.

All publications, patent applications, and technical standards mentioned in this specification are herein incorporated by reference to the same extent as if each individual publication, patent application, or technical standard was specifically and individually indicated to be incorporated by reference.

### BACKGROUND OF THE INVENTION

1. Field of the Invention

The present invention relates to an inkjet recording medium production method.

2. Description of the Related Art

Inkjet recording media are known, for use as recording media in inkjet recording methods, that have a porous ink absorbing layer, made from a pigment such as amorphous silica and a water soluble binder such as a polyvinyl alcohol, provided on a support such as paper.

A recording medium has been proposed, for example in Japanese Patent Application (JP-A) No. S64-11877, that is obtained by coating a paper support with a silicon containing pigment such as silica and a water based binder. Also, described in JP-A No. H11-34481 is a recording medium that uses silica particles synthesized by a gas phase method (referred to below as vapor-phase silica). Furthermore, there is a recording medium described in JP-A No. H6-199034 that uses alumina and alumina hydrates.

The vapor-phase silica and alumina and alumina hydrates are ultra fine particles with an average primary particle diameter of from a few nm to a few tens of nm, and have the merit of being able to obtain a high glossiness and high ink absorbability. However, on the other hand there is the problem that, because they are ultra fine particles, the surface of such ink absorbing layers is readily scratched, and since there is high glossiness, such scratches tend to stand out.

Also, paper has been widely used conventionally as the support in inkjet recording media. Paper itself fulfils the role of an ink absorbing layer. Recently, with the desire for photo-like recording sheets, there are problems with recording sheets using a paper support with regard to their glossiness, texture, water resistance, cockling after printing (creasing or rippling) and the like. Therefore, water proofed paper supports, for example resin laminated paper (polyolefin resin coated paper) that has a polyolefin resin such as polyethylene laminated onto both sides thereof, and plastic films and the like are becoming used. However, since the surface of ink absorbing layers provided on these water resistant supports have a high smoothness, in contrast to the surface of paper supports, problems arise of: (1) scratches being readily generated on the ink absorbing layer surface due to rubbing when this face is stacked against the reverse face; and (2) double feeding when printing. Furthermore, since the water proof support does not itself have any ink absorbing capacity, the ink absorbing layer must have a large ink absorbing capacity. There is, therefore, a need for a thick coating with inorganic fine particles layer with a high porosity. In order to raise the porosity, the proportion of the organic binder relative to the inorganic fine particles must be decreased. But, by reducing the amount of organic binder the film of the ink absorbing layer becomes brittle, and scratches arise even more readily. This phenomenon is even more pronounced when using vapor-phase silica, alumina and alumina hydrate particles that are ultra fine particles with an average primary particle diameter of 50 nm or less.

As technologies for solving the sort of problems described above, there has been a proposal to provide a layer (glossy layer) including colloidal silica in an upper layer, such as for example in JP-A No. H6-183131. However, simply by providing a glossy layer as an upper layer has not enabled glossiness, ink absorbability and scratch resistance to all be provided to a satisfactory extent at the same time.

Furthermore, the use of a matting agent for the purpose of improving scratch resistance has been described in JP-A No. H11-321080.

### SUMMARY OF THE INVENTION

The present invention has been made in view of the above circumstances and provides an inkjet recording medium production method.

A first aspect of the present invention provides an inkjet recording medium production method comprising at least forming an ink absorbing layer on or above a support, wherein the ink absorbing layer comprises vapor-phase silica and at least two matting agents having different number average particle diameters and having distribution degree of 0.2 or less.

A second aspect of the present invention provides an inkjet recording medium production method comprising at least forming an ink absorbing layer and a glossy layer on or above a support, wherein the ink absorbing layer comprises vapor-phase silica, the glossy layer comprises colloidal silica, and either the ink absorbing layer or the glossy layer comprises at least two matting agents having different number average particle diameters and having distribution degree of 0.2 or less.

### DETAILED DESCRIPTION OF THE INVENTION

A description will be given below of details of an inkjet recording medium production method of the present invention.

The first inkjet recording medium production method of the invention includes at least forming an ink absorbing layer on or above a support, wherein the ink absorbing layer comprises vapor-phase silica and at least two matting agents having different number average particle diameters and having distribution degree of 0.2 or less.

The second inkjet recording medium production method includes at least forming an ink absorbing layer and a glossy layer on or above a support, wherein the ink absorbing layer comprises vapor-phase silica, the glossy layer comprises colloidal silica, and either the ink absorbing layer or the glossy layer comprises at least two matting agents having different number average particle diameters and having distribution degree of 0.2 or less.

Since an inkjet recording medium manufactured by the first inkjet recording medium production method includes at least two matting agents having different number average particle diameters and having distribution degree of 0.2 or less, the inkjet recording medium has an excellent sense of surface glossiness.

Also, since an inkjet recording medium manufactured by the second inkjet recording medium production method includes at least two matting agents having different number average particle diameters and having distribution degree of 0.2 or less, in either the ink absorbing layer or the glossy layer, the inkjet recording medium has excellent sense of surface glossiness and also excellent scratch resistance.

An inkjet recording medium manufactured by the first or the second inkjet recording medium production methods (referred to sometimes below simply as the production method of the present invention) may be such that the surface of the inkjet recording medium on the side on which the ink absorbing layer is formed, when measured according to JIS B0601, has an Ra of less than 0.1 μm with a cut-off value of 0.05 to 0.5 mm and an Ra of less than 0.40 μm with a cut-off value of 1 to 3 mm, and according to JIS Z8741 has a 60° glossiness degree of 50 or more. By the production method of the present invention, the surface may hold a sense of glossiness even with the above particular Ra values. If the Ra values are outside of the above particular ranges then problems in resistance to scratches scarcely occur.

It has been confirmed by the inventors that the Ra values with cut-off values of 0.05 to 0.5 mm and of 1 to 3 mm each have a large influence on blur and distortion of images projected onto the print face. When the values of the Ra, with cut-off values of 0.05 to 0.5 mm and at 1 to 3 mm are, respectively, 0.1 μm or greater, or 0.40 μm or greater, then blur and distortion of images projected onto the print face becomes great, and the quality of the photographic images suffers greatly, therefore the values of the Ra with cut-off values of 0.05 to 0.5 mm and 1 to 3 mm are made respectively less than 0.1 μm and less than 0.40 μm.

Furthermore, for an inkjet recording medium manufactured according to the production method of the present invention, the difference in the glossiness between white portions and black portions may be reduced when using pigment inks for the following reason.

Normally, when pigment inks are printed on glossy paper the glossiness of the printed portions is decreased, and there is a large difference thereof to that of the non printed portions, and a problem arises with photographic quality images. However, by adding monodispersed matting agent, the glossiness of the white portions may be decreased appropriately. In contrast, the glossiness of the black regions hardly varies from that of an inkjet recording medium without the addition of such a matting agent. Therefore, the difference in the glossiness between the white portions and the black portions may be suppressed, and photographic quality may be maintained.

There is no particular limitation to the configuration of the inkjet recording medium according to the present invention, but it is preferable that an ink absorbing layer and a glossy layer are provided on or above a support in this order. Also, other layers may be formed according to the requirements. When the inkjet recording medium related to the present invention has a glossy layer, then it is preferable that the glossy layer is provided as the outermost layer, and it is more preferable that the ink absorbing layer and the glossy layer as the outermost layer are provided in this order on the support, with the ink absorbing layer and the glossy layer adjacent to each other.

The inkjet recording medium according to the present invention is provided with an ink absorbing layer that includes vapor-phase silica. The ink absorbing layer may include other inorganic fine particles in addition to vapor-phase silica. Preferable examples of such other inorganic fine particles include alumina and alumina hydrates. The total amount included in the ink absorbing layer of vapor-phase silica, together with any other inorganic fine particles other than vapor-phase silica that are used according to requirements, is preferably 50% by weight or more relative to the total solid content of the ink absorbing layer, with 60% by weight or more being more preferable, and 65% by weight being particularly preferable. The total amount of vapor-phase silica, together with any other inorganic fine particles other than vapor-phase silica that are used according to requirements, included in the ink absorbing layer (if there are two or more ink absorbing layers provided then the total amount therein) is preferably 10 to 50 g/m², and more preferably 15 to 40 g/m².

When other inorganic fine particles other than vapor-phase silica are used in combination, then the included proportion of the vapor-phase silica to the other inorganic fine particles (by weight) is preferably from 95:5 to 20:80, and more preferably from 90:10 to 50:50.

In the present invention there may be a single layer or multiple layer structure of the ink absorbing layer. In the case of a single layer, for example, either of a configuration with only vapor-phase silica or a configuration with vapor-phase silica used together with other inorganic fine particles may be adopted. When there is a multiple layer structure then there are, for example, configurations with multi-layers including only vapor-phase silica, or configurations with different other inorganic fine particles included in separate layers, but examples of basic configurations that may be given are a double layer configuration with one layer including vapor-phase silica and one layer including alumina or alumina hydrate, or a configuration in which vapor-phase silica of different particle diameters are included in separate layers.

The vapor-phase silica for use in the present invention is also called dry method silica, in contrast to wet method silica, and is generally produced by a flame hydrolysis method. Specifically, there is a generally known method for producing vapor-phase silica by combustion of silicon tetra chloride in hydrogen and oxygen. Instead of silicon tetra chloride, silanes, such as methyl trichloro silane and trichloro silane, may be used on there own or in combinations with silicon tetra chloride. Commercially available vapor-phase silicas may be obtained, including Trade Name: AEROSIL, manufactured by Nippon Aerosil Co. Ltd., and Trade Name: QS TYPE, manufactured by Tokuyama Corporation.

The average primary particle diameter of the vapor-phase silica is preferably 5 to 50 nm, and in order to obtain an even higher gloss, it is preferably 5 to 20 nm with a specific surface area according to the BET method of 90 to 400 m²/g. The BET method used in the present invention is a method of determining the surface area of powder by gas-phase adsorption, more specifically a method of determining the specific surface area, i.e., the total surface area per g of a sample, from the absorption isotherm. Nitrogen gas is commonly used as the adsorption gas, and most widely used is a method of determining the amount of adsorption by the change in pressure or volume of the adsorbed gas. One of the most famous equations describing the adsorption isotherm of multi-molecular system is the equation of Brunauer, Emmett, and Teller (BET equation). The surface area is calculated by multiplying the adsorption amount determined by the BET equation by the surface area occupied by a single adsorbed molecule.

As the alumina used in the present invention it is preferable to use gamma-alumina, which are gamma phase crystals of aluminum oxide, and within the different types of alumina delta group crystals are more preferable. Gamma-alumina may be made into small primary particles of the order of 10 nm in size, but usually it is preferable to use secondary particles of several thousand to several tens of thousands of nm in size, irradiating these with ultrasound or pulverizing in a high pressure homogenizer, opposing jet impact pulverizer, or the like, down to about 50 to 300 nm.

The alumina hydrate of the present invention is typically represented by the formula Al₂O₃.nH₂O (where n=1 to 3). When n=1 this represents a boehmite structure, and when n is larger than 1 but less than 3 then it represents a pseudo boehmite structure. Alumina hydrate may be obtained by a known production method, such as hydrolysis of aluminum alkoxides such as aluminum isopropoxide, neutralization by the alkali of an aluminum salt, and hydrolysis of aluminate salts.

The alumina hydrate average primary particle diameter is preferably 5 to 50 nm, and in order to obtain an even higher gloss, it is preferably to use tabular particles with an average primary particle diameter of 5 to 20 nm with an average aspect ratio (a ratio of average particle diameter to average thickness) of two or more.

In the present invention, in order to maintain the film characteristics, it is preferable that an organic binder is included in the ink absorbing layer. As such an organic binder, various water-soluble polymers or polymer latexes are preferably used. Examples that may be given for use as such water-soluble polymers are polyvinyl alcohols, polyethylene glycols, starches, dextrins, carboxymethylcellulose, polyvinyl pyrrolidone, polyacrylic ester based polymers, and derivatives thereof. Especially preferable as organic binders are completely or partially saponificated polyvinyl alcohols or cation modified polyvinyl alcohols.

Particularly preferable among polyvinyl alcohols are those that are saponificated to between 80% and 100%. Polyvinyl alcohols with an average degree of polymerization of 500 to 5000 are preferable. Also, examples that may be given of cation modified polyvinyl alcohols are those polyvinyl alcohols with a primary to tertiary amino group or a quarternary ammonium group in the main polyvinyl alcohol chain or in a side chain, like those described in, for example, JP-A No. S61-10483.

Moreover, examples that may be given of polymer latexes for use as an organic binder include, for example: acrylic based latexes, such as acrylic esters or methacrylic esters containing an alkyl group, an aryl group, an aralkyl group, a hydroxy alkyl group, or the like; homopolymers or copolymers of acrylonitrile, acrylamide, acrylic acid, and methacrylic acid; or copolymers of the above-mentioned monomers with styrene sulfonic acid, vinylsulfonic acid, itaconic acid, maleic acid, fumaric acid, maleic anhydride, vinylisocyanate, an allylisocyanate, vinylmethyl ether, vinyl acetate, styrene, divinylbenzene, or the like. For olefin based latexes, polymers from copolymers of a vinyl monomer and a diolefin are preferable. Preferably used as such a vinyl monomer are styrene, acrylonitrile, methacrylonitrile, methyl acrylate, methyl methacrylate, vinyl acetate and the like; examples that may be given of such a diolefin are butadiene, isoprene, chloroprene, and the like.

In the ink absorbing layer of the present invention, it is preferable to use such an organic binder within the range of 5 to 35% by weight relative to the inorganic particles, and use within 10 to 30% by weight is particularly preferable.

In the ink absorbing layer of the present invention it is preferable to include a cationic compound. By including a cationic compound in the ink absorbing layer it is possible to achieve improvement in prevention of cracking and in the water resistance of the ink absorbing layer. Furthermore, by providing a layer including colloidal silica and a cationic compound, on the ink absorbing layer that has such a cationic compound included, the scratch resistance, water resistance and ink absorbing ability may be raised even further, and aggregation at the boundary of the two layers is prevented, and as a result, uneven coating and uneven glossiness may be eliminated.

Cationic compounds that may be used in the present invention preferably include cationic polymers or water soluble polyvalent metal compounds. Such cationic polymers or water soluble polyvalent metal compounds may be used singly or in combinations thereof.

Examples that may be given of such cationic polymer used for the present invention include water-soluble cationic polymers which have a quaternary ammonium group, a phosphonium group, or an acid addition product of a primary to tertiary amine. For example, polyethyleneimine, a dialkyldiallylamine polymer, an allylamine polymer, a condensation polymer of an alkylamine with epichlorohydrin, and the cationic polymers described in JP-A Nos. S59-20696, 59-33176, 59-33177, 59-155088, 60-11389, 60-49990, 60-83882, 60-109894, 62-198493, 63-49478, 63-115780, 63-280681, JP-A Nos. H1-40371, 6-234268, 7-125411, and 10-193776 and the like. The weight average molecular weight of the cationic polymer used for the present invention is preferably 100,000 or less, and more preferably 50,000 or less, with a lower limit thereto being about 2000.

The amount used of such cationic polymers is preferably within the range of 1 to 10% by weight relative to the inorganic particles.

Examples that may be given of polyvalent metals in such water soluble polyvalent metal compounds include: calcium, barium, manganese, copper, cobalt, nickel, aluminum, iron, zinc, zirconium, titanium, chromium, magnesium, tungsten, and molybdenum, and it can use as water soluble salt of these metal. Specific examples that may be given of the water soluble polyvalent metal compounds include: calcium acetate, calcium chloride, calcium formate, calcium sulfate, barium acetate, barium sulfate, barium phosphate, manganese chloride, manganese acetate, manganese formate dihydrate, manganese sulfate ammonium hexahydrate, cupric chloride, copper (II) ammonium chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidosulfate tetrahydrate, aluminum sulfate, aluminum sulfite, aluminum thiosulfate, polyaluminum chloride, aluminum nitrate nonahydrate, aluminum chloride hexahydrate, ferrous bromide, ferrous chloride, ferric chloride, ferrous sulfate, ferric sulfate, zinc bromide, zinc chloride, zinc nitrate hexahydrate, zinc sulfate, zirconium acetate, zirconium nitrate, basic zirconium carbonate, zirconium hydroxide, ammonium zirconium carbonate, potassium zirconium carbonate, zirconium sulfate, zirconium fluoride, zirconium chloride, zirconium chloride octahydrate, zirconium oxychloride, zirconium hydroxychloride, titanium chloride, titanium sulfate, chromium acetate, chromium sulfate, magnesium sulfate, magnesium chloride hexahydrate, magnesium citrate nonahydrate, sodium phosphotungstate, sodium citrate tungsten, 12-tungstophosphoric acid n hydrate, 12-tungstosilicic acid 26 hydrate, molybdenum chloride, 12-molybdophosphoric acid n hydrate and the like. Among these the water soluble salts of aluminum or the periodic table group IVa elements (zirconium, titanium) are preferable. The term water soluble, as used in the present invention, means that 1% by weight or more dissolves in water at ordinary temperature and ordinary pressure.

As water soluble aluminum compounds, basic polyaluminum hydroxide compounds may be preferably used. These compounds, the main components of which are shown in Formulae 1, 2 and 3, are the basic water soluble polyaluminum hydroxide which stably contain polynuclear condensation ions, such as [Al₆(OH)₁₅]³⁺, [Al₈(OH)₂₀]⁴⁺, [Al₁₃(OH)₃₄]⁵⁺, [Al₂₁(OH)₆₀]³⁺, and the like.

[Al₂(OH)ₙCl₆₋ₙ]ₘ Formula 1

[Al(OH)₃]ₙAlCl₃ Formula 2

Alₙ(OH)ₘCl₍₃ₙ₋ₘ₎ 0<m<3n Formula 3

These are sold as chemicals for water treatment as polyaluminum chloride (PAC) from Taki Chemical Co., Ltd., as polyaluminum hydroxide (Trade Name: PAHO) by Asada Chemical Industry Co. Ltd. also as Trade Name: PURACHEM WT by Riken Green Co., Ltd., and these are marketed for the same purposes by other manufacturers, and various grades can easily be obtained. These commercially available products may be used in the present invention as they are. These basic polyaluminum hydroxide compounds are also described in Japanese Patent Application Publication (JP-B) Nos. H3-24907 and 3-42591.

In the present invention the amount included of the above water soluble polyvalent metal compounds in the ink absorbing layer is 0.1 g/m² to 10 g/m², and is preferably 0.2 g/m² to 5 g/m².

In the present invention in order to improve the brittleness of the membrane of the ink absorbing layer various oil droplets may be appropriately included. As such oil droplets, a hydrophobic high boiling point organic solvent with a solubility in water at room temperature of 0.01% by weight or less may be included (for example, liquid paraffin, dioctyl phthalate, tricresyl phosphate, silicon oil and the like) and polymer particles (for example, particles polymerized from one or more type of polymerizable monomer, such as styrene, butyl acrylate, divinylbenzene, butyl methacrylate, and hydroxyethyl methacrylate) may be included. These oil droplets are preferably used within the range of 10 to 50% by weight relative to any organic binder.

In the present invention, it is preferable to include a hardening agent together with an organic binder in the ink absorbing layer. Specific examples of such a hardening agent include: aldehyde based compounds like formaldehyde and glutaraldehyde; ketone compounds like diacetyl, chloropentanedione; bis(2-chloro ethylurea)-2-hydroxy-4,6-dichloro-1,3,5triazine; compounds having reactive halogen like those described in U.S. Pat. No. 3,288,775; divinyl sulfone; compounds with reactive olefins like those described in U.S. Pat. No. 3,635,718; N-methylol compounds like those described in U.S. Pat. No. 2,732,316; isocyanates like those described in U.S. Pat. No. 3,103,437; aziridine compounds like those described in U.S. Pat. Nos. 3,017,280 and 2,983,611; and carbodiimide compounds like those described in U.S. Pat. No. 3,100,704; epoxy compounds like those described in U.S. Pat. No. 3,091,537; and the halogen carboxyaldehydes like mucochloric acid; dioxane derivatives like dihydroxydioxane; and inorganic hardening agent like chrome alum, zirconium sulfate, boric acid, boric acid salts and the like. These may be used singly or in combinations thereof. Among these boric acid or a boric acid salt are preferable. The addition of a hardening agent is preferably to the amount of 0.1 to 40% by weight relative to the organic binder in the ink absorbing layer, and is more preferably 0.5 to 30% by weight.

In the ink absorbing layer, various well-known additives may also be added, such as: fixing agents for dye colorants, pigment colorants, and ink dyes; ultraviolet absorbers; antioxidants; pigment dispersants; defoaming agents; leveling agents; preservatives; fluorescent whitening agents; viscosity stabilizers; and pH adjusting agent. Moreover, the pH of the coating liquid of an ink absorbing layer is preferably in the range of pH 3.3 to 6.0, and is particularly preferably in the range of pH 3.5 to 5.5. By a combination of the ink absorbing layer coating liquid having this pH, and the coating liquid of a layer containing colloidal silica in the range of pH 3.3 to 6, a coating surface that has even more ink absorbency, glossiness and uniformity may be obtained.

In the present invention the layer thickness of the ink absorbing layer is preferably from 5 to 50 μm, and more preferably from 15 to 40 μm. Here, when there are plural ink absorbing layers present, then “the layer thickness of the ink absorbing layer” means the total thickness of all of the plural ink absorbing layers.

The inkjet recording medium manufactured according to the second inkjet recording medium production method is provided with a glossy layer including colloidal silica. The glossy layer is preferably the outermost surface layer (outermost layer).

The colloidal silica used for the present invention is silicon dioxide in a colloidal form dispersed in water, obtained by heat aging a silica sol obtained by double decomposition of sodium silicate by an acid or the like, or passing sodium silicate through an ion exchange resin layer. It is wet method synthesis silica with a primary particle diameter of several nanometers up to about 100 nm. As such colloidal silica, Trade Name: SNOWTEX ST-20 ST-30, ST-40, ST-C, ST-N, ST-20L, ST-O, ST-OL, ST-S, ST-XS, ST-XL, ST-YL, ST-ZL, ST-OZL, ST-AK, etc., from Nissan Chemical Industries, Ltd. are commercially available.

The colloidal silica used in the present invention preferably has an average primary particle diameter within the range of 30 nm to 100 nm, from the point of view of ink absorbing ability and glossiness. Furthermore, it is preferable to use a combination of two or more colloidal silicas that have different average primary particle diameters from each other. In such a case, it is even more preferable to use a combination of one colloidal silica with an average primary particle diameter of 30 nm or more to less than 60 nm together with another colloidal silica with an average primary particle diameter of 60 nm or more to 100 nm or less. The proportion of colloidal silica with an average primary particle diameter of 30 nm or more to less than 60 nm relative to the total amount of colloidal silica is preferably 60% by weight or above.

As to the particle shape of such colloidal silicas, there are spherical, and chain shaped (beaded shaped), but spherical colloidal silicas are preferable from the point of view of scratch resistance and glossiness. Also, the above colloidal silicas may be anionic, nonionic or cationic, but are preferably anionic from the point of view of the stability of the glossy layer coating liquid, and in particular the stability of coating liquids including polyvinyl alcohols as the organic binder (the coagulation and separating out of the colloidal silica due to a coating liquid aging).

The colloidal silica solids coating amount in the glossy layer is preferably within the range of 0.1 to 8.0 g/m², and more preferably 0.3 g to 5.0 g/m². By being so, there is no reduction in the ink absorbing ability but a significant improvement in the glossiness and in the scratch resistance may be achieved.

In the present invention a cationic compound may be included in the glossy layer. As the cationic compound a cationic polymer or a water soluble polyvalent metal compound are preferably used. The details regarding such cationic polymers and water soluble polyvalent metal compounds are the same as those of the above explanation for the ink absorbing layer. In the present invention a cationic polymer is preferable used as the cationic compound used in the glossy layer.

The addition amount of the above cationic compound is preferably 0.1 to 10% by weight relative to the colloidal silica, and more preferably 0.5 to 8.0% by weight.

An organic binder is furthermore preferably included in the glossy layer. It is preferable that the amount used of such an organic binder is 10% by weight or less relative to the colloidal silica, with the lower limit being of the order of about 0.5% by weight. More preferable is to use an organic binder within the range of 1 to 7% by weight. By including an organic binder within such ranges the scratch resistance may be improved without a decrease in the ink absorbing ability.

For such an organic binder the same organic binders may be used as described above for the organic binder used in the ink absorbing layer. Particularly preferable from these organic binders are completely or partly saponificated polyvinyl alcohols or cationic modified polyvinyl alcohols. Particularly preferable from such polyvinyl alcohols are ones with a saponification of 80% to 100%. Polyvinyl alcohols are preferable used with an average degree of polymerization in the order of about 500 to 5000.

Furthermore, for the cationic modified polyvinyl alcohols examples include those with a primary to tertiary amino group or a quarternary ammonium group in the main polyvinyl alcohol chain or in a side chain, like those described in, for example, JP-A No. S61-10483.

In the glossy layer a hardener may be used with an organic binder. Examples that may be given of such a hardener include those used as the hardener in the ink absorbing layer. Among these hardeners, boric acid or salts of boric acid are particularly preferably used. Also, surfactants, coloration dyes, coloration pigments, UV absorbers, antioxidants, pigment dispersing agents, defoaming agents, leveling agents, preservatives, fluorescent whitening agents, viscosity stabilizers, pH adjusting agents and the like may be included in the glossy layer.

The layer thickness of the glossy layer is preferably between 0.01 to 5 μm, and more preferably 0.02 to 1 μm.

There are at least two matting agents, having different number average particle diameters and having distribution degree of 0.2 or less, included in the ink absorbing layer of an inkjet recording medium manufactured according to the first inkjet recording medium production method, or included in the ink absorbing layer or the glossy layer of an inkjet recording medium manufactured according to the second inkjet recording medium production method.

The at least two matting agents may be included in the ink absorbing layer or the glossy layer of an inkjet recording medium manufactured according to the second inkjet recording medium production method, however there are preferably included in a glossy layer that is located more to an upper layer side than the ink absorbing layer.

The distribution degree according to the present invention indicates a value represented by standard deviation/average particle diameter. The standard deviation and the average particle diameter are calculated based on a (ΣNV²/ΣNV) value (where V represents the equivalent spherical particle diameter of individual particles, and N is the number of particles with the equivalent spherical particle diameter of V). The equivalent spherical particle diameter is obtained by the determination of the particle diameter distribution of the matting agents using a coulter counter.

In the present invention, it is necessary for the distribution degrees of the matting agents to be 0.2 or less in order to avoid deteriorating glossiness. The smaller the distribution degree is, the more preferable it is, and from this definition, the lower limit of the distribution degree is zero.

The matting agents are water insoluble organic or inorganic particles and, for example, the following may be used in the present invention: titanium oxide, silica particles, glass powder, barium sulfate, polystyrene, polymethylmethacrylate, polycarbonate, and polyacrylate copolymers, as long as the distribution degree is 0.2 or less.

Here, the particles used for the matting agent are preferably dispersion of single particles rather than of aggregate bodies.

In the present invention it is preferable that, for the matting agents, the inequality Da/Db>1.5 is satisfied, where a matting agent A has the largest number average particle diameter Da, and a matting agent B has the smallest number average particle diameter Db.

Sufficient scratch resistance effect can be obtained by satisfying Da/Db>1.5. Da/Db is still more preferably 2.0 or more.

When using the above two kinds of matting agents, matting agent A and matting agent B, together the mixing ratio (by weight) of matting agent A and matting agent B is preferably from 95:5 to 10:90, and more preferably from 90:10 to 30:70.

In the present invention, it is preferable that the number average particle diameters of the matting agents are 1 to 25 μm. If the number average particle diameter of a matting agent is 1 μm or more, sufficient scratch resistance effect may be obtained. Moreover, sufficient glossiness is maintainable if the number average particle diameter is 25 μm or less. The number average particle diameter of matting agent A is preferably 12 to 25 μm, and more preferably 15 to 22 μm. The number average particle diameter of matting agent B is preferably 1 to 15 μm and more preferably 2 to 12 μm.

The number average particle diameter indicates a measurement value using a Coulter counter.

The coating amount of the matting agents is preferably 0.001 to 10 g/m², and 0.005 to 5 g/m² is more preferable. Here, the coating amount of matting agents means the total coating amount of the two or more matting agents.

The first ink jet recording medium production method has at least the process of forming an ink absorbing layer, and the second ink jet recording medium production method has at least the processes of forming an ink absorbing layer and of forming a glossy layer. The ink absorbing layer may be formed by applying the coating liquid of the ink absorbing layer containing vapor-phase silica onto a support, and drying. The glossy layer can be formed by applying the coating liquid of the glossy layer containing colloidal silica onto a support, and drying.

In the first inkjet recording medium production method, coating of the ink absorbing layer may be performed, for example using a blade coater, an air knife coater, a roll coater, a bar coater, a gravure coater, a reverse coater, or the like.

In the second ink jet recording medium production method the method for applying the ink absorbing layer and the glossy layer may be a sequential coating method, which coats one layer at a time (for example using a blade coater, an air knife coater, a roll coater, a bar coater, a gravure coater, a reverse coater, or the like), or the method may be a simultaneous multilayer coating method (for example using a slide bead coater, a slide curtain coater, or the like), however, preferably a simultaneous multilayer coating method is used.

Although it was common conventionally to carry out sequential coating of the ink absorbing layer and the glossy layer (for example, the method of carrying out coating and drying of the glossy layer after coating and drying the ink absorbing layer), however, when carrying out sequential coating, if the coating amount of the colloidal silica in the glossy layer by solid content is below 8 g/m², and more so when below 5 g/m², it turns out that the effect of the glossiness and scratch resistance of the glossy layer is not fully demonstrated. This is thought to be because some of the glossy layer coating liquid permeates into voids in the ink absorbing layer when a comparatively thin layer glossy layer is applied onto the coated and dried ink absorbing layer containing the vapor-phase silica, and therefore a uniform glossy layer could not be obtained. Moreover, the air which exists in the voids in the ink absorbing layer diffuses into the upper layer glossy layer coating liquid, becoming bubbles, to generate crater-like coating defects (crater-like pinholes), also becoming an impediment to the uniformity of the coating of the glossy layer.

Furthermore, when the glossy layer is applied after carrying out coating and drying of the ink absorbing layer, if vapor-phase silica is used as inorganic particles in the ink absorbing layer, then micro cracks may be caused in the ink absorbing layer due to the process in which the ink absorbing layer becomes wet again and then dries.

The problem when carrying out sequential coating of a comparatively thin layer for the glossy layer after the coating and drying of the ink absorbing layer is eliminated by carrying out simultaneous multilayer coating of the ink absorbing layer and the glossy layer. In the present invention, a thin layer coating of the glossy layer is preferable in respect of ink absorbency. Since colloidal silica is inferior in ink absorbency compared with other inorganic particles, such as vapor-phase silica used in the ink absorbing layer of the present invention, alumina or hydrated alumina, when preparing the glossy layer as the upper layer a thin layer is preferable. On the other hand, colloidal silica is excellent in glossiness and scratch resistance, and if a uniform coating surface can be formed, even if it is a thin layer, a sufficiently high effect of glossiness and scratch resistance may be obtained. Therefore, in order to have a satisfactory high level of ink absorbency, glossiness, and scratch resistance, it is very preferable to carrying out simultaneous multilayer coating of a thin layer of the glossy layer with the ink absorbing layer.

Simultaneous multilayer coating applies the plural coating liquids of the ink absorbing layer and the glossy layer to a support in a layered state using a coater, such as a slide bead coater or a slide curtain coater. In the state in which the coating liquids of the ink absorbing layer and the glossy layer are layered, a new problem occurs in that sometimes aggregation may readily take place at the interface of the two layers. This problem may be solved by including a cationic compound in the glossy layer, and adjusting the pH of the coating liquid to the range of pH 3.3 to 6.0, and preferably in the range of pH 3.5 to 5.5.

A preferable composition of the glossy layer is as described above, and about 3 to 25% by weight is suitable for the concentration of the colloidal silica in the coating liquid of this layer, with 5 to 15% by weight more preferable. The wet coating amount of the glossy layer coating liquid is preferably about 10 to 50 g/m², and 10 to 30 g/m² is more preferable.

Although the composition of the ink absorbing layer is described above, in the coating liquid of the ink absorbing layer the concentration of the inorganic particles (sum of vapor-phase silica and of other inorganic particles other than the vapor-phase silica used as required) is preferably about 5 to 20% by weight. When there are two or more layers for the ink absorbing layer, it is preferable that the concentration of the inorganic particles is within the above range in each such layer. A total of about 100 to 300 g/m² is suitable for the wet coating amount of the ink absorbing layer coating liquid(s) whether there be one or plural thereof. The pH of the coating liquid of the ink absorbing layer is preferably in the range of pH 3.3 to 6, and is particularly preferably in the range of pH 3.5 to 5.5. By adjusting to pH to within these ranges, ink absorbency improves and aggregation at the interface with the glossy layer is also further suppressed.

As the support used in the present invention, waterproof supports are preferably, such as: plastic resin films, such as polyester resins such as polyethylene terephthalate, diacetate resins, triacetate resins, acrylic resins, polycarbonate resins, polyvinyl chloride, polyimide resins, cellophane, and celluloid; paper and a resin film bonded together; or an polyolefin resin coated paper in which a hydrophobic resin, such as polyolefin resin, is laminated to at least on one side of a sheet of paper. The thickness of such a waterproof support is 50 to 300 μm, and is preferably 80 to 260 μm.

Details of a polyolefin resin coated-paper support (referred to below as polyolefin resin coated paper) that is preferably used for the present invention will now be explained. There is no particular limitation to the water content of the polyolefin resin coated paper used for the present invention, however, from a viewpoint of curl characteristics, it is preferably in the range of 5.0 to 9.0%, and 6.0 to 9.0% is more preferable. The water content of such a polyolefin resin coated paper may be measured using a chosen method for determination of moisture. For example, an infrared moisture meter, an oven dry weight method, a permittivity method, a Karl Fischer technique or the like may be used.

The base paper which constitutes the polyolefin resin coated paper does not have any particular limitations and a generally used paper may be used, however, it is more preferably to use a smooth base paper such as, for example, a support used for photographs. The following examples of techniques may be given as production methods of a support which has good smoothness, with a small Ra.

Pulp blending techniques (using a pulp blend which readily becomes soft when heated), and using combinations of sheet making conditions (optimization of the calendar pressure and temperature, optimization of the jet/wire ratio, and the like) may be given as examples of methods to provide a small Ra in a long wavelength range (cut-off value of 1 mm or more). There is no particular limitation to the pulp used, and according to the application, a softwood pulp, a hardwood pulp, or a synthetic pulp of a plastic material such as polyethylene or polypropylene may be used, or a mixture of a synthetic pulp and a natural pulp may be used.

In order to raise the flatness characteristics and dimensional stability of the base paper to a sufficient level, a hardwood pulp is preferable, but a softwood pulp may be used. Hardwood bleached kraft pulp (LBKP), hardwood bleached sulfite pulp (LBSP) and the like may be given as examples of such hardwood pulps, and among these a hardwood bleached kraft pulp is preferable.

Although there is no particular limitation with regard to the content of the above hardwood pulp, 50% or more is preferable, 60% or more is more preferable, and 75% or more is still more preferable.

Moreover, as a method of making the base paper mechanically smooth, it is preferable to carry out smoothing treatment by performing the press dry treatment and calendering process described in JP-A No. 2005-54279, paragraphs (0024) to (0034).

Moreover, although smoothness characteristics may be improved greatly by optimizing the jet/wire ratio as defined at (0023) of JP-A 2004-216667, the optimal range is about 0.95 to 1.05, and it is preferable to carry out paper making within this range according to the application.

As a method for making a small Ra in a short wavelength region (cut-off value 0.5 mm or less) there is a large effect by having a thickness of a polyolefin resin layer that is more than 30 g/m². It is preferably more than 35 g/m².

As the pulp which constitutes the base paper, a natural pulp, a recycled pulp, a synthetic pulp or the like may be used either as a single type of pulp, or in a combination of two or more thereof. Additives generally used by paper making are blended with this base paper, such as sizing agents, paper reinforcing agents, fillers, antistatic agents, fluorescent whitening agents, and colorants.

Furthermore, surface coating with a surface-size agent, surface paper reinforcing agent, fluorescent whitening agent, antistatic agent, colorant, anchor agent or the like may be carried out.

Moreover, although there is no particular limitation to the thickness of the base paper, good surface smoothness by applying pressure by calendering or the like to the paper, during sheet making or after sheet making, to compress the paper, and the basis weight is preferably 30 to 250 g/m².

Polymers which may be used as a polyolefin resin which covers the base paper include: homopolymers such as low density polyethylene, high density polyethylene, polypropylene, polybutene, and polypentene; copolymers thereof consisting of two or more olefins, such as ethylene-propylene copolymer; and mixtures thereof. These have various densities and melt viscosity indexes (melt indexes) and they may be used singly or mixed together.

Moreover, it is preferable to add appropriate combinations of various additives to the resin of the polyolefin resin coated paper, the additives including: white pigments, such as titanium oxide, zinc oxide, talc, and calcium carbonate; fatty acid amides, such as stearic acid amide, arachidic acid amide, fatty acid metal salts, such as zinc stearate, calcium stearate, aluminum stearate and magnesium stearate; antioxidants, such as IRGANOX 1010 and IRGANOX 1076; blue pigments and dyes, such as cobalt blue, ultramarine blue, cerulean blue, and phthalocyanine blue; magenta pigments and dyes, such as cobalt violet, fast violet, and manganese purple; fluorescent whitening agents; and ultraviolet absorbers.

The main production method of polyolefin resin coated paper is production by so-called extrusion coating method in which polyolefin resin is flow cast onto a running base paper in a heat-melted state, and at least one side of the basepaper is covered with resin. Also, before covering the resin onto the base paper, it is preferable to perform activation of the base paper, such as by corona discharge treatment or flame treatment. It is preferable from the point of view of ink absorbency not to cover resin onto the face of the basepaper on which the ink absorbing layer is provided (front surface of the base paper), and from the point of prevention of curl it is preferable to provide a resin layer on the opposite side (reverse face of the base paper). The reverse face is usually a non-glossy side and activation treatment by corona discharge treatment, flame treatment or the like may also be carried out to the reverse face or both sides as required. Moreover, although there is no particular limitation to the thickness of such a resin coating layer, generally resin coating is carried out to the thickness of 5 to 50 μm per one resin coating layer on one surface side or both surface sides. When carrying out the resin coating only to one side, the thickness of such a polyolefin resin covering layer is preferably about 5 to 25 μm from the point of view of the curl characteristics of the ink jet recording medium obtained.

For the front surface of the polyolefin resin coated paper of the present invention (surface where the ink absorbing layer is coated) the surface of the base paper may be used as it is. However, from the viewpoint of improving the glossiness and smoothness characteristics, a polyolefin resin covering layer may be formed by heat melting of the polyolefin resin with an extruder, extruding the polyolefin resin between the base paper and a chill roll (cooling roll) in a film form, adhering it by pressure and cooling it. In this case the chill roll is used for formation of the surface shape of the polyolefin resin coating layer, and molding may be carried out of the surface of the resin layer with the surface of such a chill roll shaped as a mirrored surface, a finely roughened surface, or patterned to a silk finish, a mat finish or the like.

For the rear surface of the polyolefin resin coated paper of the present invention (surface opposite to the surface where the ink absorbing layer is coated) the surface of the base paper may be used as it is. However, from viewpoints of improving curl characteristics and printed images, a polyolefin resin covering layer may be formed by heat melting mainly polyolefin resin with an extruder, extruding the polyolefin resin in a film form between the base paper and a chill roll, adhering it by pressure and cooling it. In this case, from the viewpoint of conveying characteristics in a printer, and of printing images, it is preferable to molding process this reverse face so as to give an Ra specified in JIS-B-0601 on the reverse face of 0.8 to 5 μm, by shaping the surface of the chill roll to a finely roughened surface or patterning it to give, for example, a silk finish, a mat finish or the like. Moreover, it is preferable that inorganic fine particles, such as a polymer latex, silica, or alumina, are applied to the reverse face from the viewpoint of the runability of the image receiving paper.

Methods available for providing the polyolefin resin coating layer on the rear surface and/or the front surface of the base paper, other than extruding and coating a thermo-melting resin, include: methods of coating with an electron beam curable resin and then irradiating with an electron beam; and methods of coating with a coating liquid of a polyolefin resin emulsion, then drying and carrying out surface smoothing treatment. In both such cases a polyolefin resin coated paper that may be applied to the present invention may be obtained by carrying out molding using a heated roller or the like that has a roughened surface.

An undercoat layer may be provided to the surface of the polyolefin resin coated paper used for the present invention. Coating and drying of this undercoat layer is carried out to the surface of a waterproof support before the ink absorbing layer is coated. Such an undercoat layer mainly includes a layer formable water-soluble polymer, a polymer latex or the like. Preferably examples of water-soluble polymers include gelatin, polyvinyl alcohols, polyvinyl pyrrolidones, and water-soluble cellulose, and gelatin is especially preferably. The coating weight of these water-soluble polymers is preferably 10 to 500 mg/m², and 20 to 300 mg/m² is more preferable. Furthermore, it is preferable to also include a surfactant and a hardening agent in the undercoat layer. Moreover, before applying such an undercoat layer to the resin coated paper, it is preferable to carry out corona discharge.

Exemplary embodiments are given below of the present invention. However, the present invention is not limited to these exemplary embodiments.

<1> An inkjet recording medium production method comprising at least forming an ink absorbing layer on or above a support, wherein the ink absorbing layer comprises vapor-phase silica and at least two matting agents having different number average particle diameters and having distribution degree of 0.2 or less.

<2> The inkjet recording medium production method according to <1>, wherein the surface of the inkjet recording medium on the side on which the ink absorbing layer is formed, when measured according to JIS B0601, has an Ra of less than 0.11™ with a cut-off value of 0.05 to 0.5 mm and an Ra of less than 0.40 μm with a cut-off value of 1 to 3 mm, and according to JIS Z8741 has a 60° glossiness degree of 50 or more.

<3> The inkjet recording medium production method according to <1>, wherein, of the matting agents, a matting agent A having the largest number average particle diameter Da, and a matting agent B having the smallest number average particle diameter Db, satisfy the inequality Da/Db>1.5.

<4> The inkjet recording medium production method according to <1>, wherein the number average particle diameters of the matting agents are 1 to 25 μm.

<5> The inkjet recording medium production method according to <1>, wherein the vapor-phase silica has an average primary particle diameter of 5 to 20 nm and a specific surface area measured by the BET method of 90 to 400 m²/g.

<6> An inkjet recording medium production method comprising at least forming an ink absorbing layer and a glossy layer on or above a support, wherein the ink absorbing layer comprises vapor-phase silica, the glossy layer comprises colloidal silica, and either the ink absorbing layer or the glossy layer comprises at least two matting agents having different number average particle diameters and having distribution degree of 0.2 or less.

<7> The inkjet recording medium production method according to <6>, wherein the surface of the inkjet recording medium on the side on which the ink absorbing layer is formed, when measured according to JIS B0601, has an Ra of less than 0.1 μm with a cut-off value of 0.05 to 0.5 mm and an Ra of less than 0.40 μm with a cut-off value of 1 to 3 mm, and according to JIS Z8741 has a 60° glossiness degree of 50 or more.

<8> The inkjet recording medium production method according to <6>, wherein, of the matting agents, a matting agent A having the largest number average particle diameter Da, and a matting agent B having the smallest number average particle diameter Db, satisfy the inequality Da/Db>1.5.

<9> The inkjet recording medium production method according to <6>, wherein the number average particle diameters of the matting agents are 1 to 25 μm.

<10> The inkjet recording medium production method according to <6>, wherein the vapor-phase silica has an average primary particle diameter of 5 to 20 nm and a specific surface area measured by the BET method of 90 to 400 m²/g.

<11> The inkjet recording medium production method according to <6>, wherein the colloidal silica has an average primary particle diameter of 30 to 100 nm.

<12> The inkjet recording medium production method according to <6>, wherein the colloidal silica comprises anionic colloidal silica.

<13> The inkjet recording medium production method according to <6>, wherein the solid matter coating amount of the colloidal silica in the glossy layer is 0.1 to 8.0 g/m².

<14> The inkjet recording medium production method according to <6>, wherein the ink absorbing layer and the glossy layer are coated by simultaneous multilayer coating.

### EXAMPLES

Further details of the present invention will be explained below, based on examples, however the present invention is not limited to these examples.

### Example 1

—Support Production—

Beating was carried out with a double disc refiner of 75 parts of hardwood bleached kraft pulp (LBKP) and 25 parts of acacia bleached kraft pulp (LBKP), respectively, and a pulp slurry of 330 ml Canadian freeness (Canadian standard freeness) was obtained.

Then, to the obtained pulp slurry, was added, relative to the pulp: 1.3% of cationic starch (Trade Name: CATO304L, made by Nippon NSC Ltd.); 0.15% of anionic polyacrylamide (Polyacron ST-13, made by Seiko Chemical Industries Co., Ltd.); 0.29% of anionic ketene dimer (Trade Name: SIZEPINE K, made by Arakawa Chemical Industries, Ltd.); 0.29% of epoxidized behenic acid amide; and 0.32% of polyamide polyamine epichlorohydrin (Trade Name: ARAFIX 100, made by Arakawa Chemical Industries, Ltd.); and then afterwards 0.12% of a defoaming agent was further added.

After performing paper making with a Fourdrinier machine, using the pulp slurry prepared as described above, using a jet/wire ratio of 1.03, dewatering was carried out, and the wet sheet after dewatering was dried using a press dry apparatus (Trade Name: STATIC CONDEBELT made by Valmet Corporation), as shown in FIG. 1 of JP-A No. 2005-54279, for the above described press dry treatment, and the base paper with a moisture content after drying of 7.0% was produced. In the above press dry treatment the temperature of the upper plate which touches the surface side of a base paper on which the ink absorbing layer is to be provided (front surface) was adjusted to 150° C., and the temperature of the lower plate which touches the surface side of a base paper on which the ink absorbing layer is not provided (reverse face) was adjusted to 85° C., and performed at a pressing pressure of 0.4 MPa, and drying time of 1 second.

Then, using a soft calendar device, the base paper which has had the above press dry treatment carried out thereon was calendar treated with a metal roll with a surface temperature of 250° C. to the surface side on which an ink absorbing layer is to be provided (front surface) and a resin roll at the opposite side with a surface temperature of 40° C., making a sheet of 190 μm thick base paper with a basis weight of 200 g/m², and the base paper was obtained.

After performing corona discharge treatment to the wire surface side (reverse face) of the obtained base paper, high density polyethylene was coated using a melt-extruder, so as to be 40 μm in thickness, and a polyethylene resin layer with a mat surface was formed (this polyethylene resin layer side is hereafter called the “reverse face”). After performing further corona discharge treatment to the surface of the polyethylene resin layer at the side of this reverse face, a dispersion liquid with dispersed aluminum oxide (antistatic agent, Trade Name: ALUMINASOL 100, made by Nissan Chemical Industries Ltd.) and silicon dioxide (SNOWTEX 0, made by Nissan Chemical Industries Ltd.) in water with a weight ratio of 1:2 was applied so that dry weight becomes 0.2 g/m².

Furthermore, after performing corona discharge treatment to the felt face side (front surface) to which the polyethylene resin layer is not provided, low density polyethylene, containing (relative to the polyethylene) 10% of anatase titanium dioxide, a trace amount of ultramarine blue (made by Tokyo Printing Ink Manufacturing Co., Ltd.), and 0.08% of a fluorescent whitening agent (Trade Name: WHITEFLOUR PSN CONC, made by Nippon Chemical Works Co., Ltd.) at a MFR (melt flow rate) of 3.8, was extruded using a melt extruder so as to give a layer thickness of 40 μm, and with the nip pressure between a resilient roll and a chill roll set to 3.5 MPa, a high gloss polyethylene resin layer was formed on the front surface side of the base paper (this high gloss surface is referred to as the “front surface”), thereby making the support.

In addition, the material that was used for the resilient body which constitutes the resilient roll was an ethylene propylene rubber, of hardness 80 value according to JIS K-6301, and that with a wall thickness of 25 mm. Moreover, the roughness of the roll surface of the resilient roll was a value of 0.3 S according to JIS B-0601.

After performing high frequency corona discharge treatment to the front surface of the above support, coating and drying of an undercoat layer of the following composition was carried out so that gelatin was coated at 50 mg/m², and the support was produced. Here “parts” indicates parts by weight of solid content.

<Undercoat layer>

| | |
|---|---|
| Lime treated gelatin | 100 parts |
| Sulfosuccinic acid 2-ethylhexyl ester salt | 2 parts |
| Chrome alum | 10 parts |

Simultaneous multilayer coating of the ink absorbing layer coating liquid and the glossy layer coating liquid of the following composition was carried out by a slide bead coater to the surface of the obtained support provided with the undercoat layer. The ink absorbing layer coating liquid was prepared so that the concentration of the vapor-phase silica therein was 9% by weight. The wet coating amount of the ink absorbing layer coating liquid was 200 g/m² (the solid content coating amount of vapor-phase silica was 18 g/m²). The glossy layer coating liquid was prepared so that the concentration of the colloidal silica therein was 8% by weight. The wet coating amount of the glossy layer coating liquid was 12.5 g/m² (the solid content coating amount of colloidal silica was 1 g/m²).

<Ink absorbing layer coating liquid>

| | | |
|---|---|---|
| Vapor-phase silica | 100 | parts |
| (average primary particle diameter 7 nm, specific surface area 300 m²/g by the BET method) | | |
| 3,6-dithio-1,8-octanediol | 3 | parts |
| Homopolymer of dimethyl diallyl ammonium chloride | 4 | parts |
| (Trade Name: SHALLOL DC902P; made by Dai-ichi Kogyo Seiyaku Co., Ltd., | | |
| molecular weight 9000) | | |
| Boric acid | 3 | parts |
| Polyvinyl alcohol | 22 | parts |
| (degree of saponification 88%, average degree of polymerization 3500) | | |
| Basic polyaluminum hydroxide | 3 | parts |
| (Trade Name: PURACHEM WT, made by Riken Green Co., Ltd.) | | |
| Surfactant | 0.3 | parts |
| (Betaine series; Trade Name: SWANOLAM; made by Nihon Surfactant Kogyo K.K.) | | |
| The pH of the coating liquid was adjusted to pH 4.0. | | |

<The glossy layer coating liquid>

| | | |
|---|---|---|
| Colloidal silica | 100 | parts |
| (Anionic spherical colloidal silica; Trade Name: SNOWTEX ST-OL40 made by Nissan | | |
| Chemical Industries Ltd., average primary particle diameter 40 to 50 nm) | | |
| Cationic polymer | 1 | part |
| (Trade Name: POLYFIX 601 made by Showa Highpolymer Co., Ltd., a special modified | | |
| polyamine) | | |
| Polyvinyl alcohol | 4 | parts |
| (degree of saponification 88%, average degree of polymerization 3500) | | |
| Surfactant | 0.3 | parts |
| (Betaine series; made by Nihon Surfactant Kogyo K.K., Trade Name: SWANOLAM) | | |
| Matting agent A | 4 | parts |
| (PMMA particles, made by Soken Chemical & Engineering Co., Ltd., number average | | |
| particle diameter 20 μm, distribution degree of 0.10) | | |
| Matting agent B | 20 | parts |
| (PMMA particles, made by Soken Chemical & Engineering Co., Ltd., number average | | |
| particle diameter 10 μm, distribution degree of 0.10) | | |

The above glossy layer coating liquid was produced as follows.

First water was added and a colloidal silica aqueous solution was prepared so that the concentration of colloidal silica was 10% by weight, then while carrying out high-speed stirring of this colloidal silica aqueous solution with a high speed rotational dispersion device, the matting agents and POLYFIX 601 (10% by weight solution) were added, and after carrying out high-speed stirring for a further 10 more minutes, the coating liquid was produced by adding the polyvinyl alcohol and the surfactant in that order. The pH of this coating liquid was pH 3.0.

Simultaneous multilayer coating of the above ink absorbing layer coating liquid and the glossy layer coating liquid, respectively, was carried out and the ink jet recording medium according to Example 1 was produced. The Ra value, scratch resistance, blank glossiness degree, glossiness degree after printing (black), and the glare were evaluated using the following respective methods.

The results are shown in Table 1.

### Examples 2 to 10 and Comparative Examples 1 to 7

Ink jet recording media were produced in the same way as in Example 1, except for using the matting agents A and B shown in Table 1, and evaluation thereof was in the same way as in Example 1. The results are shown in Table 1. Each of the matting agents used in the Examples 2 to 10 and in the Comparative Examples 1 to 7 was made by Soken Chemical & Engineering Co., Ltd.

### Examples 11

An ink jet recording medium was produced in the same way as in Example 1, except that the thickness of the low density polyethylene on the felt face side was made 25 μm, and evaluation thereof was in the same way as in Example 1. The results are shown in Table 1.

### Examples 12 to 21 and Comparative Examples 8 to 14

Ink jet recording media were produced in the same way as in Example 1, except for using the ink absorbing layer coating liquids with additives of the matting agents shown in Table 2, and not applying the glossy layer coating liquid. Evaluation thereof was in the same way as in Example 1. The results are shown in Table 2. Each of the matting agents used in the Examples 12 to 21 and Comparative Examples 8 to 12 was made by Soken Chemical & Engineering Co., Ltd. The matting agents of the Comparative Examples 13 and 14 were made by Sekisui Plastics Co., Ltd.

<Measurement of Ra Value>

The Ra value (arithmetic average roughness) with a cut-off of 0.05 mm to 0.5 mm was measured using a three-dimensional surface structure analysis microscope (Trade Name; ZYGO NEW VIEW 5000, made by Zygo Corporation) under the following measurement and analysis conditions.

<Measurement and Analysis Conditions>

Measurement length: 10 mm in the X direction, 10 mm in the Y direction

Objective lens: 2.5 times

Band pass filter: 0.05 mm to 0.5 mm

The Ra value (arithmetic average roughness) with a cut-off of 1 mm to 3 mm was measured using a surface profile measuring apparatus (Trade Name: NANO METRO 110F, made by Kuroda Precision Industries, Ltd.) on the basis of the following measurement and analysis conditions.

<Measurement and Analysis Conditions>

The scan direction: machine direction of sample

Measurement length: 50 mm in the X direction, 30 mm in the Y direction

Measurement pitch: 0.01 mm in the X direction, 1.0 mm in the Y direction

Scanning rate: 2 mm/s

Band pass filter: 1 mm to 3 mm

<Blank Glossiness Degree>

60° specular gloss was measured by the method described in JIS Z8741 to obtain the blank glossiness degree.

<Glossiness Degree After Printing>

Solid printing was performed with the maximum jetting amount of black pigment using a pigment printer (Trade Name:V630, made by Seiko Epson Corporation) and the 60° specular gloss of the formed solid image was measured as described in JIS Z8741 to obtain the glossiness degree after printing.

<Glare>

Cyan printing on the inkjet recording medium was performed (with maximum density) with the pigment printer V630 of Seiko Epson Corporation at 23° C./60% RH atmosphere, and, after putting the inkjet recording medium in a 23° C./60% RH environment for one day, the glare condition (the condition in which blue changes to red under a fluorescent lamp) was evaluated according to the following criteria.

C: Red is distinctly visible

B: Red is slightly visible

A: Red is not at all visible

<Scratch Resistance>

The front surface was visually inspected for abrasion scratches from conveying when evaluating the glossiness after printing and glare. The degree of abrasion scratches was evaluated according to the following criteria.

A: No abrasion scratches at all

B: 1 to 2 slight abrasion scratches discernable

C: Slight abrasion scratches across the whole of the surface, but at a level that does not really affect the print quality

D: Prominent abrasion scratches across the whole of the surface with a large deterioration in the print quality.

TABLE 1

| | Matting Agent B | | | | Matting Agent A | | |
|---|---|---|---|---|---|---|---|
| | | Particle | | | | Particle | |
| | | diameter/ | Distribution | Add. amount | | diameter/ | Distribution |
| | Type | μm | degree | (parts) | Type | μm | degree |
| Ex. 1 | PMMA | 10 | 0.10 | 20 | PMMA | 20 | 0.10 |
| Ex. 2 | PMMA | 10 | 0.10 | 40 | PMMA | 20 | 0.10 |
| Ex. 3 | PMMA | 10 | 0.10 | 20 | PMMA | 15 | 0.10 |
| Ex. 4 | PMMA | 10 | 0.10 | 40 | PMMA | 15 | 0.10 |
| Ex. 5 | PMMA | 5 | 0.10 | 30 | PMMA | 20 | 0.10 |
| Ex. 6 | PMMA | 5 | 0.10 | 50 | PMMA | 20 | 0.10 |
| Ex. 7 | PMMA | 3 | 0.10 | 50 | PMMA | 20 | 0.10 |
| Ex. 8 | PMMA | 3 | 0.10 | 100 | PMMA | 20 | 0.10 |
| Ex. 9 | PMMA | 1.5 | 0.10 | 100 | PMMA | 20 | 0.10 |
| Ex. 10 | PMMA | 1.5 | 0.10 | 200 | PMMA | 20 | 0.10 |
| Ex. 11 | PMMA | 10 | 0.10 | 20 | PMMA | 20 | 0.10 |
| Comp. Ex. 1 | PMMA | 10 | 0.10 | 24 | | | |
| Comp. Ex. 2 | PMMA | 10 | 0.10 | 48 | | | |
| Comp. Ex. 3 | PMMA | 20 | 0.10 | 10 | | | |
| Comp. Ex. 4 | PMMA | 20 | 0.10 | 40 | | | |
| Comp. Ex. 5 | PMMA | 5 | 0.10 | 58 | | | |
| Comp. Ex. 6 | PMMA | 10 | 0.10 | 20 | MBX 20 | 20 | 0.356 |
| Comp. Ex. 7 | PMMA | 10 | 0.10 | 40 | MBX 20 | 20 | 0.356 |

| | Matting | | | | | Glossiness | |
|---|---|---|---|---|---|---|---|
| | Agent A | Ra/μm | | | Blank | degree | |
| | Add. amount | Cut-off: | Cut-off: | Scratch | Glossiness | after printing | |
| | (parts) | 0.05-0.05 mm | 1-3 mm | Resistance | Degree | (Black) | Glare |
| Ex. 1 | 4 | 0.090 | 0.285 | B | 60 | 58 | B |
| Ex. 2 | 8 | 0.095 | 0.290 | A | 58 | 55 | A |
| Ex. 3 | 8 | 0.090 | 0.289 | B | 61 | 55 | B |
| Ex. 4 | 16 | 0.098 | 0.294 | B | 60 | 54 | A |
| Ex. 5 | 4 | 0.086 | 0.280 | B | 61 | 55 | A |
| Ex. 6 | 8 | 0.088 | 0.282 | B | 59 | 53 | B |
| Ex. 7 | 5 | 0.082 | 0.276 | B | 59 | 55 | A |
| Ex. 8 | 10 | 0.086 | 0.280 | B | 59 | 54 | A |
| Ex. 9 | 4 | 0.081 | 0.274 | B | 59 | 54 | A |
| Ex. 10 | 10 | 0.083 | 0.280 | B | 58 | 52 | A |
| Ex. 11 | 4 | 0.115 | 0.400 | A | 55 | 58 | B |
| Comp. Ex. 1 | | 0.086 | 0.270 | D | 70 | 58 | C |
| Comp. Ex. 2 | | 0.090 | 0.285 | D | 68 | 55 | C |
| Comp. Ex. 3 | | 0.088 | 0.282 | C | 60 | 58 | B |
| Comp. Ex. 4 | | 0.110 | 0.309 | B | 38 | 20 | A |
| Comp. Ex. 5 | | 0.070 | 0.255 | D | 73 | 68 | C |
| Comp. Ex. 6 | 4 | 0.102 | 0.302 | B | 48 | 25 | A |
| Comp. Ex. 7 | 8 | 0.115 | 0.312 | A | 30 | 12 | A |

TABLE 2

| | Matting Agent B | | | | Matting Agent A | | | |
|---|---|---|---|---|---|---|---|---|
| | | Particle | | Addition | | Particle | | Add. |
| | | diameter/ | Distribution | amount | | diameter/ | Distribution | amount |
| | Type | μm | degree | (parts) | Type | μm | degree | (parts) |
| Ex. 12 | PMMA | 10 | 0.10 | 1.1 | PMMA | 20 | 0.10 | 0.2 |
| Ex. 13 | PMMA | 10 | 0.10 | 2.2 | PMMA | 20 | 0.10 | 0.4 |
| Ex. 14 | PMMA | 10 | 0.10 | 1.1 | PMMA | 15 | 0.10 | 0.4 |
| Ex. 15 | PMMA | 10 | 0.10 | 2.2 | PMMA | 15 | 0.10 | 0.9 |
| Ex. 16 | PMMA | 5 | 0.10 | 1.7 | PMMA | 20 | 0.10 | 0.2 |
| Ex. 17 | PMMA | 5 | 0.10 | 2.8 | PMMA | 20 | 0.10 | 0.4 |
| Ex. 18 | PMMA | 3 | 0.10 | 2.8 | PMMA | 20 | 0.10 | 0.3 |
| Ex. 19 | PMMA | 3 | 0.10 | 5.5 | PMMA | 20 | 0.10 | 0.6 |
| Ex. 20 | PMMA | 1.5 | 0.10 | 5.5 | PMMA | 20 | 0.10 | 0.2 |
| Ex. 21 | PMMA | 1.5 | 0.10 | 11.0 | PMMA | 20 | 0.10 | 0.6 |
| Comp. Ex. 8 | PMMA | 10 | 0.10 | 1.3 | | | | |
| Comp. Ex. 9 | PMMA | 10 | 0.10 | 2.7 | | | | |
| Comp. Ex. 10 | PMMA | 20 | 0.10 | 0.6 | | | | |
| Comp. Ex. 11 | PMMA | 20 | 0.10 | 2.2 | | | | |
| Comp. Ex. 12 | PMMA | 5 | 0.10 | 3.2 | | | | |
| Comp. Ex. 13 | PMMA | 10 | 0.10 | 1.1 | MBX 20 | 20 | 0.356 | 0.2 |
| Comp. Ex. 14 | PMMA | 10 | 0.10 | 2.2 | MBX 20 | 20 | 0.356 | 0.4 |

| | | | | | Glossiness | |
|---|---|---|---|---|---|---|
| | Ra/μm | | | Blank | degree | |
| | Cut-off: | Cut-off: | Scratch | Glossiness | after printing | |
| | 0.05-0.5 mm | 1-3 mm | Resistance | Degree | (Black) | Glare |
| Ex. 12 | 0.095 | 0.285 | B | 55 | 53 | A |
| Ex. 13 | 0.098 | 0.295 | B | 52 | 51 | A |
| Ex. 14 | 0.105 | 0.295 | B | 56 | 51 | A |
| Ex. 15 | 0.105 | 0.298 | B | 55 | 52 | A |
| Ex. 16 | 0.095 | 0.295 | B | 55 | 51 | A |
| Ex. 17 | 0.098 | 0.290 | B | 54 | 50 | A |
| Ex. 18 | 0.090 | 0.285 | B | 52 | 50 | A |
| Ex. 19 | 0.096 | 0.290 | B | 54 | 50 | A |
| Ex. 20 | 0.091 | 0.286 | B | 55 | 50 | A |
| Ex. 21 | 0.095 | 0.295 | B | 53 | 50 | A |
| Comp. Ex. 8 | 0.095 | 0.285 | D | 65 | 53 | C |
| Comp. Ex. 9 | 0.095 | 0.295 | D | 63 | 50 | B |
| Comp. Ex. 10 | 0.095 | 0.295 | C | 55 | 53 | A |
| Comp. Ex. 11 | 0.120 | 0.315 | C | 32 | 15 | A |
| Comp. Ex. 12 | 0.085 | 0.270 | D | 68 | 63 | B |
| Comp. Ex. 13 | 0.110 | 0.308 | C | 43 | 20 | A |
| Comp. Ex. 14 | 0.120 | 0.320 | B | 26 | 10 | A |

MBX 20 in Tables 1 and 2 are cross-linked acrylic based fine particles.

Tables 1 and 2 show the following.

By mixing together two types of organic fine particles that have different particle diameters and have distribution degree of 0.2 or less, scratch resistance, glossiness degree after printing and glare may all be achieved at the same time.

What is claimed is:

1. An inkjet recording medium production method comprising at least forming an ink absorbing layer on or above a support, wherein the ink absorbing layer comprises vapor-phase silica and at least two matting agents having different number average particle diameters and having distribution degree of 0.2 or less.

2. The inkjet recording medium production method according to claim 1, wherein the surface of the inkjet recording medium on the side on which the ink absorbing layer is formed, when measured according to JIS B0601, has an Ra of less than 0.1 μm with a cut-off value of 0.05 to 0.5 mm and an Ra of less than 0.40 μm with a cut-off value of 1 to 3 mm, and according to JIS Z8741 has a 60° glossiness degree of 50 or more.

3. The inkjet recording medium production method according to claim 1, wherein, of the matting agents, a matting agent A having the largest number average particle diameter Da, and a matting agent B having the smallest number average particle diameter Db, satisfy the inequality Da/Db>1.5.

4. The inkjet recording medium production method according to claim 1, wherein the number average particle diameters of the matting agents are 1 to 25 μm.

5. The inkjet recording medium production method according to claim 1, wherein the vapor-phase silica has an average primary particle diameter of 5 to 20 nm and a specific surface area measured by the BET method of 90 to 400 m²/g.

6. An inkjet recording medium production method comprising at least forming an ink absorbing layer and a glossy layer on or above a support, wherein the ink absorbing layer comprises vapor-phase silica, the glossy layer comprises colloidal silica, and either the ink absorbing layer or the glossy layer comprises at least two matting agents having different number average particle diameters and having distribution degree of 0.2 or less.

7. The inkjet recording medium production method according to claim 6, wherein the surface of the inkjet recording medium on the side on which the ink absorbing layer is formed, when measured according to JIS B0601, has an Ra of less than 0.1 μm with a cut-off value of 0.05 to 0.5 mm and an Ra of less than 0.40 μm with a cut-off value of 1 to 3 mm, and according to JIS Z8741 has a 60° glossiness degree of 50 or more.

8. The inkjet recording medium production method according to claim 6, wherein, of the matting agents, a matting agent A having the largest number average particle diameter Da, and a matting agent B having the smallest number average particle diameter Db, satisfy the inequality Da/Db>1.5.

9. The inkjet recording medium production method according to claim 6, wherein the number average particle diameters of the matting agents are 1 to 25 μm.

10. The inkjet recording medium production method according to claim 6, wherein the vapor-phase silica has an average primary particle diameter of 5 to 20 nm and a specific surface area measured by the BET method of 90 to 400 m²/g.

11. The inkjet recording medium production method according to claim 6, wherein the colloidal silica has an average primary particle diameter of 30 to 100 nm.

12. The inkjet recording medium production method according to claim 6, wherein the colloidal silica comprises anionic colloidal silica.

13. The inkjet recording medium production method according to claim 6, wherein the solid matter coating amount of the colloidal silica in the glossy layer is 0.1 to 8.0 g/m².

14. The inkjet recording medium production method according to claim 6, wherein the ink absorbing layer and the glossy layer are coated by simultaneous multilayer coating.
